(19) United States
(12) Patent Application Publication
(10) Pub. No.: US 2015/0154868 A1
(43) Pub. Date: Jun. 4, 2015

(54) INTELLIGENT STATE DETERMINATION

(71) Applicants: Tomer NEUNER, Tel Aviv (IL); Itai DAVID, (US)

(72) Inventors: Tomer Neuner, Tel Aviv (IL); Itay David, Tel Aviv (IL)

(21) Appl. No.: 14/417,765

(22) PCT Filed: Jul. 27, 2013
(86) PCT No.: PCT/IL2013/050638

§ 371 Date: Jan. 27, 2015

Related U.S. Application Data
(60) Provisional application No. 61/676,342, filed on Jul. 27, 2012.

(51) Int. Cl. G08G 1/14; H04W 4/16

(52) U.S. Cl. CPC G08G 1/144; H04W 4/16

(57) ABSTRACT

Methods are introduced for determining user activity states (walking, driving, biking, jogging, etc.) using smartphone IMU and other sensors. By use of such states, a novel parking spot sharing system is implemented; walking after driving is interpreted as necessarily involving parking. Parking spots are thus recognized, and users walking towards their parked cars are propitiously prompted to share their soon-to-be-vacated spot with other users of the system desiring to park, for credit towards similar services in the future, prizes, money or other incentive.

### TECHNICAL FIELD

Embodiments of the present invention relate generally to the use of smart phone sensors for intelligent state determination and tracking of users.

### BACKGROUND

State determination is generally of interest to a large number of potential entities. The determination of a given person's state in terms of his current activities, mode of travel, and the like are currently not easily determined by simple determination of location.

Similarly, smartphone tracking is generally restricted to use of GPS for location determination. Other parameters of user behavior are generally unplumbed, while use of GPS is known to be a heavy drain on battery life. Therefore alternatives to GPS tracking constitute a long-felt need in this area.

### SUMMARY OF THE INVENTION

The foregoing embodiments of the invention have been described and illustrated in conjunction with systems and methods thereof, which are meant to be merely illustrative, and not limiting. Furthermore just as every particular reference may embody particular methods/systems, yet not require such, ultimately such teaching is meant for all expressions notwithstanding the use of particular embodiments.

### BRIEF DESCRIPTION OF THE DRAWINGS

For better understanding of the invention and to show how the same may be carried into effect, reference will now be made, purely by way of example, to the accompanying drawings.

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice. In the accompanying drawings:

FIG. 1 is a schematic diagram of the system components for carrying out the method of the present invention;

FIGS. 2A,B are flowcharts showing exemplary algorithms for determining state;

FIG. 3 is a flowchart showing an exemplary algorithm for determining whether a car is in parking state;

FIG. 4 is a flowchart showing an exemplary algorithm for determining whether a user is in walking state; and

FIG. 5 is a flowchart showing an exemplary algorithm for determining whether a user is approaching his parked car and is likely about to leave his parking spot.

### DETAILED DESCRIPTION OF PREFERRED EMBODIMENTS

The following description is provided, alongside all chapters of the present invention, so as to enable any person skilled in the art to make use of said invention and sets forth the best modes contemplated by the inventor of carrying out this invention. Various modifications, however, will remain apparent to those skilled in the art, since the generic principles of the present invention have been defined specifically to provide a means and method for providing a social parking platform. Furthermore just as every particular reference may embody particular methods/systems, yet not require such, ultimately such teaching is meant for all expressions notwithstanding the use of particular embodiments.

In the following detailed description, numerous specific details are set forth in order to provide a thorough understanding of embodiments of the present invention. However, those skilled in the art will understand that such embodiments may be practiced without these specific details. Reference throughout this specification to “one embodiment” or “an embodiment” means that a particular feature, structure, or characteristic described in connection with the embodiment is included in at least one embodiment of the invention.

The term “Smart phone” used throughout this specification refers to any mobile communication device having the required features, as specified below, for carrying out the method of the present invention. These features generally include IMU (inertial measurement unit), data connectivity, and possibly GPS.

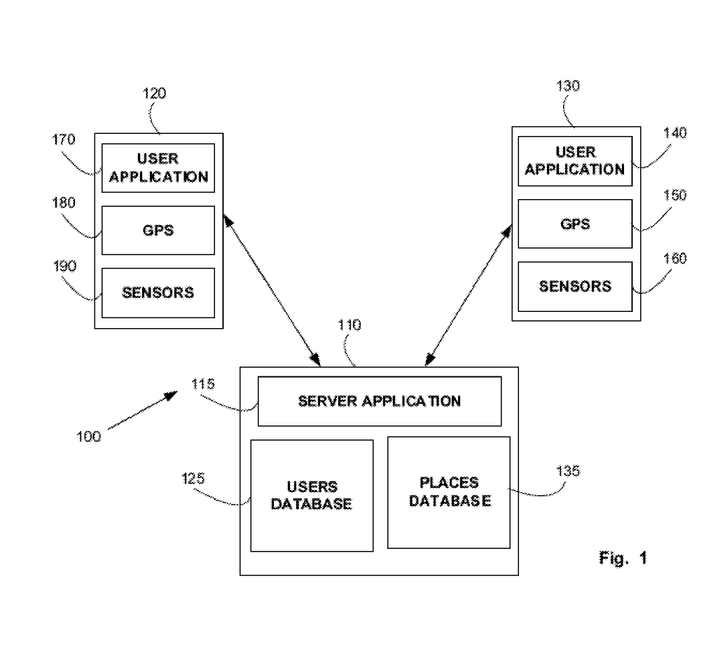

FIG. 1 is a schematic diagram of the system components for carrying out the method of the present invention. The system 100 comprises a server 110 and a plurality of mobile communication user devices (120, 130) such as smart phones and tablet PCs. Each user device comprises a processor running a user application (140, 170) using an implementation of the method according the present invention. The user application may comprise a Graphical User Interface (GUI) for communicating with the user. Each user device additionally comprises Global Positioning System (GPS) capabilities (150, 180) and a plurality of sensors (160, 190), as will be described in detail below. The system server 110 comprises a processor running a server application that communicates with the plurality of user applications. The server 110 additionally comprises at least one database for storing statuses and attributes of users and places, as will be explained in detail below.

The method according to the present invention comprises a computation engine involving a number of algorithms adapted to determine information concerning users' location, state of motion, mode of motion, etc. These features are made possible by use of device sensors including but not limited to GPS, accelerometer, magnetometer, inclinometer, IMU, gyro, camera(s), proximity sensor, light sensor, and the like. The applications may continuously detect the users' mode of transport (e.g. foot, car, bicycle, motorcycle, bus, airplane, boat); direction; location; and other parameters. Applications may further feature capabilities such as gathering information concerning users' commonly-frequented locations (home, office, transportation coridors, gym, mall); predicting users' behaviour (going to work, returning home, going shopping); and more, such capabilities potentially being useful for commercial ends, and otherwise.

The sensors are used inter alia for identifying states, for example:

1) Activity: In car (and whether driver or passenger), walking, cycling, parking, running, on bus, on motorbike. 2) Location: Indoors, outdoors.

3) Smart phone position: In stand, in pocket, laid-down, in hand, in bag.

4) Movement state: Turning right, turning left, turning rate, accelerating, acceleration rate, braking, stopped, going up, going down, as described in detail below.

The sensors used by the application may include some or all of the following sensors, as well as any other sensors providing relevant information:

a) GPS data may be used, for example, for detecting a starting point from which a user departs, such as a parking place, home, office, etc. GPS may also be of use to assist dead-reckoning methods. Similarly, after a certain number of user steps are detected during a period when GPS is off (which state is generally desirable, in order to conserve battery), algorithms of the invention may reactivate the GPS to help determine more accurately the user's current location. This may be advisable since uncorrected dead reckoning (e.g. by use of device IMU readings) will generally accumulate error and drift. b) Network location (cell-tower/wifi triangulation) may be employed when a driving state is detected (for instance by the IMU and/or GPS) to further determine (e.g. with a greater degree of certainty) that a user is in the driving state. This may be accomplished for instance by calculating the maximum speed between the ten last detected network locations (using the distances and times therebetween), and checking if this speed is greater than a driving speed threshold defined in the system.

c) Accelerometer data may be used to detect a walking state and walking speed. Similarly, driving may be detected by recognizing acceleration and deceleration patterns. Additional states may be discerned using the accelerometer (possibly in conjunction with other sensors), including but not limited to biking, driving, ascending/descending in escalators/elevators, running, and other states.

d) Magnetometer data may be used as an input for the orientation sensor and to sense the local magnetic environment.

e) Orientation sensor data may be used in conjunction with the accelerometer to detect the walking direction/driving direction, as well as detecting the phone pitch and/or other angles (which may be of use for example to help decide if the phone is held in a car stand.) Orientation data may also used along with the accelerometer to detect if the user entered the car from the driver door or the passenger door. f) Gyroscope sensor data may be used to help detect driving patterns in conjunction with the accelerometer; the gyro may be specifically used for instance to detect car turns. It may also be used in conjunction with other sensors to determine for instance device acceleration in absolute or world coordinates. Gyro data may for example be used as a rapid timescale input to a Kalman filter also using accelerometer and orientation data to determine the device orientation with respect to a real world coordinate frame.

g) Proximity sensor data may be used to detect if the phone is close to the user's body. This detection helps the algorithm to validate walking/driving assumption by knowing if the phone is in the user's pocket or next to the user's ear.

h) Light sensor data can be used to detect whether the phone is held in the user's hand or in the pocket or bag while walking. This information is then used to further increase the step counting accuracy of the walking detector.

i) Bluetooth sensor data may be used, for instance in case the user has a Bluetooth speaker kit in the car; in such a case algorithms associated with operation of the invention may identify Bluetooth connection establishment, as well as detecting the Bluetooth speaker type to determine if it is a car kit. This information is used to detect the user's proximity to the car and to detect if the user is in the car by (for example) measuring the Bluetooth RSSI link.

j) Battery charger connection identification may be used to assist the algorithm to reconfirm if the user entered driving state or in case of disconnection to re-confirm parking detection.

k) Microphone—The microphone is used to detect engine sound, seatbelt click and handbrakes pulling.

l) Pedometer—The pedometer is used to count number of steps.

In order to minimize power consumption, each sensor is activated according to certain triggers that are based on when certain conditions are met that require the sampling of that sensor. These triggers are based on information from one or more of the other sensors.

Following are some examples of state identification according to the present invention, using the smart phone sensors.

### Driving State

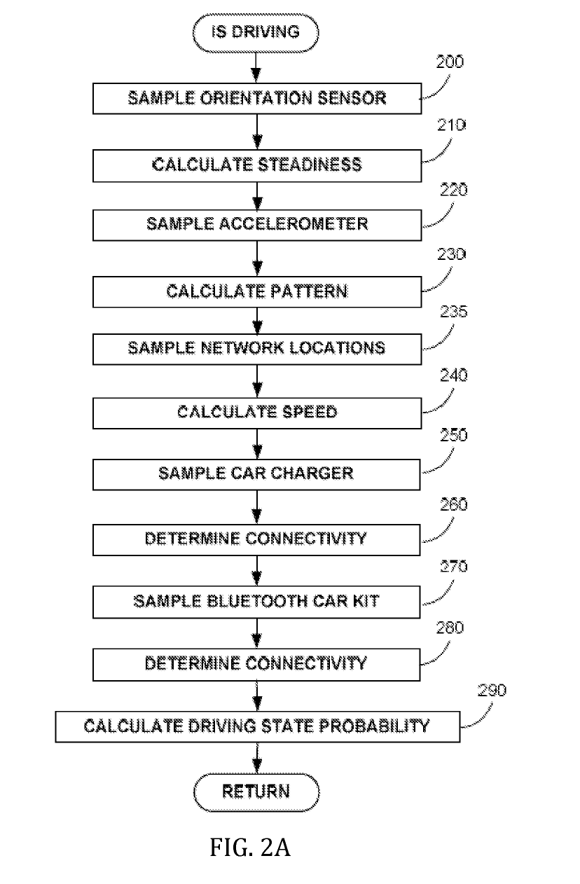

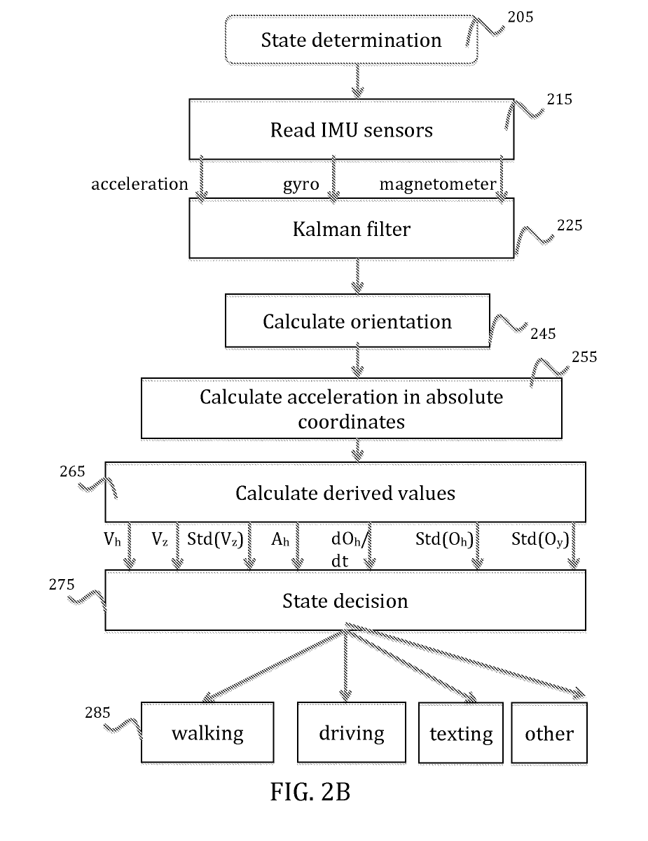

FIG. 2A is a flowchart showing an exemplary algorithm for determining whether a car is in driving state. In step 200 the orientation sensor is sampled to identify whether the orientation of the phone is fairly steady 210 (but not absolutely steady, as it would be for instance if it was lying flat on an office table). This gives an initial indication that one may be in a driving state. In step 220 the accelerometer is sampled to identify acceleration & deceleration patterns associated with driving in a city 230. This is done in one embodiment of the invention using a search window of approximately Isec that identifies the acceleration by averaging the samples over the window, and if this average is greater than a predefined threshold of acceleration, and as a predefined low enough standard deviation, then the first filter is passed. Similar analysis is performed for deceleration. Further filters are then implemented to narrow down the possible candidate events. In step 235 Network locations (cell-tower/wifi triangulation), if available, are sampled to further detect with a greater amount of certainty the driving state, by calculating the maximum speed over the most recent few location samples 240, and checking if this maximum speed is greater than a predefined driving speed threshold. Similarly, if the energy budget allows for such, the GPS may be consulted for determination of speed. Next, in step 250, the car charger is sampled: If the phone is plugged into a charger, this gives further evidence of driving. While the phone is still in the charger the system considers the user to remain in the driving state. Alternatively, if the user has a Bluetooth speaker kit in the car, the algorithm identifies the Bluetooth connection 270, as well as detecting the Bluetooth speaker type to determine if it is a car kit. This information is used to detect the user proximity to the car and to detect if the user is in the car by measuring the Bluetooth RSSI link. If the phone is plugged into a Bluetooth adapter 580, this gives further evidence of driving. While the phone is still connected to the Bluetooth adapter we consider the user to remain in a driving state. In step 590 the information derived from all the above sensors is used to determine the probability of the car being in a driving state.

It is within provision of the invention to use all of the aforemention sensors and inputs as parameters for decision functions. These decision functions may be for example classifiers, such as SVM, k-means, neural nets, Markov chains and the like.

FIG. 2B presents a more detailed view of a possible state-determination algorithm of the invention. Here the IMU sensors (acceleration, gyro, magnetometer) 215 are first read and used as input to a Kalman filter 225 adapted to calculate the orientation 245 through means that will be clear to one skilled in the art. Once the orientation is determined (and it is within provision of the invention to dispense with Kalman filter 225 and use for instance the magnetometer and accelerometer readings alone, or magnetometer alone, to determine the orientation) the acceleration may be recalculated in terms of absolute or ‘earth’ coordinates, for instance in terms of cardinal directions related to the earth such as north, upwards, and the cross product of these. Once the acceleration in absolute coordinates has been determined, values of various meaningful physical quantities may be derived including but not limited to integrals such as velocity in the horizontal plane V h, velocity in the upwards direction V z, acceleration in the horizontal direction A h, derivatives such as the rate of change of orientation in the horizontal plane O h, and standard deviations such as std(V z), std(O h), and Std(O y).

Any of these values may be calculated using one or more time windows. For example velocity can be obtained by integrating acceleration over windows of 2 seconds, 5 seconds, and 10 seconds, and each of these values may be used for the decision-making algorithm 275, which takes the various calculated values as input and outputs a state such as walking, driving, texting, and the like. Likewise, standard deviation may be calculated over various-length windows of the data history. The decision-making algorithm 275 algorithm may be any of a multitude known in the art including but not limited to neural nets, SVM, k-means, heuristics, thresholding, and the like.

It is within provision of the invention that the history of the calculated values and determined states may also be used as inputs to the state decision algorithm.

### Parking State

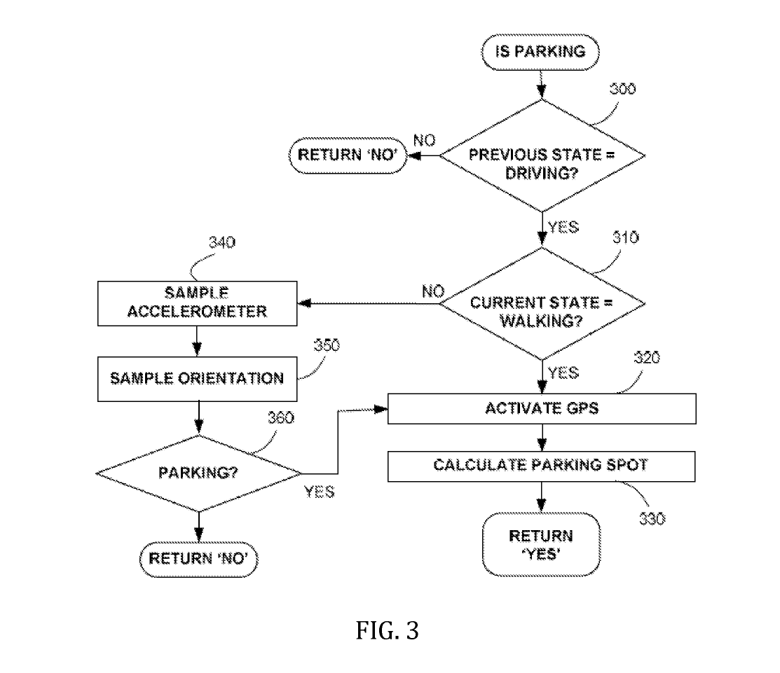

FIG. 3 is a flowchart showing an exemplary algorithm for determining whether a car is in a parking state. In one embodiment, a first condition for identifying parking is that the car's previous state was driving 300. The system then checks whether the user's current state is walking 310. If affirmative, then the transition from driving to walking is interpreted by the system as a parking event or probable parking event (for example employing fuzzy logic for non-Boolean values). The parking event is used as a trigger to activate the GPS 320 and calculate the location of the parking spot 330, which will be used for identifying when the user is re-approaching the car. However, it may take a while for the GPS to lock on to a signal, and during this time the user may have walked some distance from the car. Therefore in order to accurately calculate the parking spot, the system may use a dead-reckoning mechanism, as will be explained in detail below, to work out the distance and the direction the user has taken during the time the GPS took to lock on a signal, and backtrack this path to estimate the exact location of the car. If in step 310 the user's current state has not been identified as walking, the system may sample the accelerometer 340 and orientation 350 sensors to identify “parallel parking” motion or “alley-docking” motion.

To identify parallel parking, the system uses the accelerometer and orientation sensors (which may be a fused sensor comprising magnetometer, gyro, and accelerometer data input to a Kalman filter to determine orientation, for instance) to identify the motion of moving backwards and forwards (and possibly also repeated a few times as the driver corrects) as the driver is parallel parking. The expected accelerations are combined with the information on the orientation of the phone to more acccurately identify parking; during actual parallel parking, the phone changes orientation according to a canonical parallel parking “path” (point straight ahead, slowly turn to one side, then gently turn back to the original direction).

Similarly, to identify alley docking, the system uses the accelerometer to identify the motion of moving backwards, combined with the information on the orientation of the phone, as the phone changes orientation according to the alley docking “path” (point straight ahead, gently swerve to the one side, at around 90 degrees from the starting orientation.

As mentioned above the identification of parallel parking/alley docking states is assisted by identification of a walking state following soon after, which supports the conclusion that the user just parked and thus increases the confidence that the suspected movements (of the accelerometer and the orientation sensors) were indeed parallel parking/alley docking. It is within provision of the invention to supply as output a measure of confidence in addition to the identity of the state; that is, the system may be so adapted as to output a “walking 90% confidence” state or even mixed states such as “walking 90% confidence, driving 10% confidence”.

If parking state 360 is identified, the system may activate the GPS 320 even while the person is still in the car, thus reducing the time taken from parking to GPS lock. This may also be used to neutralize false-positives (false assesments of driving or walking or any other state, in this case driving in particular) returned from other forms of movement, e.g. taxi, buses, bicycle, motorbikes, etc. which do not parallel park or alley dock. The system may also use the microphone to further assist in the accurate identification of parking—for example the microphone may be used to detect engine sound, seatbelt click and handbrake-pulling.

### Walking State

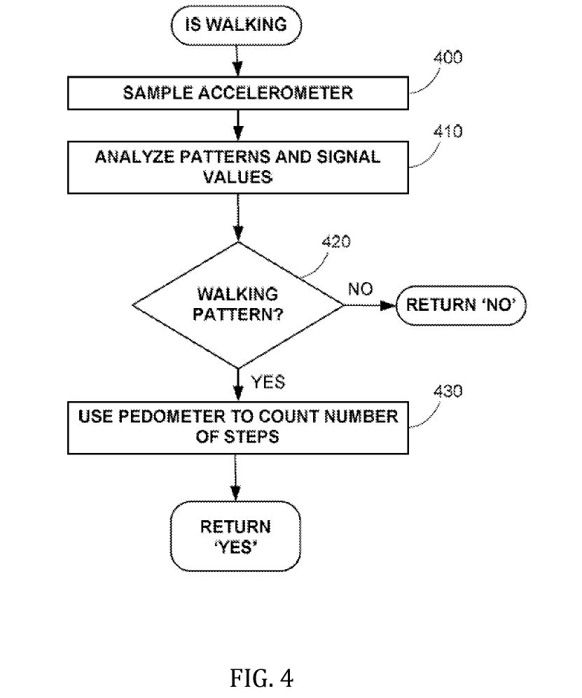

FIG. 4 is a flowchart showing an exemplary algorithm for determining whether a user is in walking state. In step 400 the accelerometer is sampled, By analyzing the information from the accelerometer and other sensors 410, the system can identify the characteristic patterns of a person walking. Walking is characterized by wave-like periodic patterns in the accelerometer and orientation readings. Identification of this pattern may be achieved in several ways. In one embodiment, the algorithm looks at the acceleration value signals (the total acceleration vector from the x, y & z components) and identifies peaks (local maxima) that pass a predefined upper threshold, which are followed consecutively by dips (local minima) below a second predefined threshold. The thresholds may be set equal for all users or customized according to the specific user's walking style. This customization per user is accomplished in some embodiments by identifying that the user is walking using other sensors (see below) and learning the appropriate thresholds for the user. The magnitude of the acceleration vector when the phone is idle is 9.8 m/ŝ2 (gravity). In general, the upper threshold for the acceleration vector magnitude is around 10.4-10.8, and the lower 8.8-9.2, but this depends on a number of factors, predominantly the sample frequency. If the upper threshold is exceeded, the algorithm looks for values lower than the lower threshold within a predefined window of time (about 200 ms-500 ms from the max threshold break, which is equal to approx 0.66-5 steps per second). The algorithm searches for patterns going from dip to peak and back to dip again, etc. If this pattern is maintained for a predefined minimum period of time (around 2-4 seconds) then the walking state is determined. Once a walking state has been determined 420, the pedometer may be used 430 to count the number of steps taken by the user, where each dip and each peak is considered a step.

It is further within provision of the invention to employ frequency detection methods such as Fourier transform and PSD (power spectral density) to determine principle frequency components of acceleration and orientation; when most energy is concentrated in a characteristic frequency band of several Hz, this is characteristic of walking and hence sensor histories not having such characteristics may be eliminated from consideration as being from a walking state.

### Approaching Starting Point

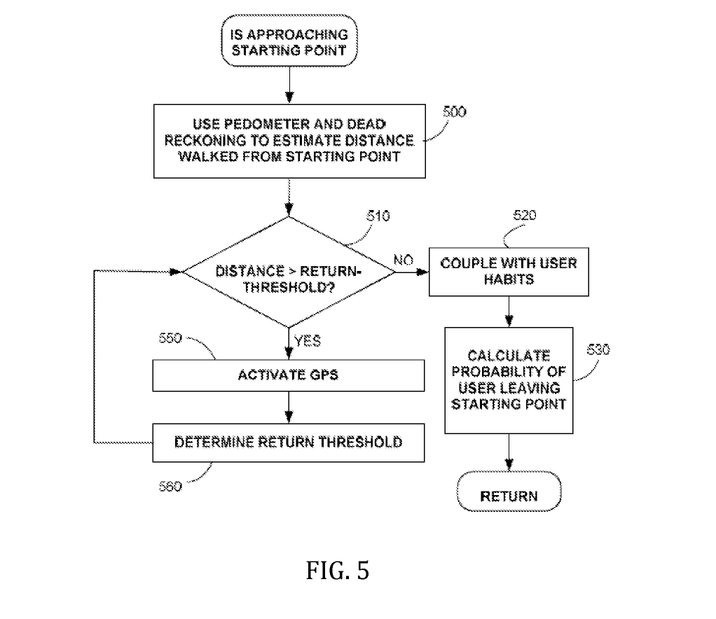

FIG. 5 is a flowchart showing an exemplary algorithm for determining whether a user is approaching a point he has previously left and is supposed to return to, such as his parked car, his home, office, etc. Using the pedometer the system can estimate the number of steps taken by the user and thus estimate the distance walked by the user away from the starting point 500. The system also has access to data concerning the direction walked, using dead reckoning and/or the device orientation sensor(s), and thus can determine the user's position relative to the starting point, albeit with deteriorating accuracy as the distance grows. If the accuracy is too low, (for instance as inferred from the distance measured being greater than a predefined return-threshold 510), the system may activate the GPS 550 for a short period of time to get an exact location of the user, following which the GPS may be switched off and dead-reckoning used again. The accuracy which is considered low enough to activate the GPS is based on the distance from the starting point—the further away from the starting point, the less important the accuracy, The system looks for the maximum distance the user has walked from the starting point. This can be defined by aerial distance, or actual walking distance. Based on the maximum distance reached from the starting point, the algorithm determines the return-threshold distance from the starting point at which it determines that the user is approaching the starting point; the greater the maximum distance, the greater the threshold. For example, if the maximum distance from the starting point is only 120 m, then the return-threshold may be 80 m; if the max distance is 500 m, then the return-threshold may be around 220 m. In step 520, once the user's distance from the starting point has been determined to be smaller than the return-threshold, a further assessment of the user actually being on his way to return to the starting point may be done by looking at the user's historical habits stored on the system server's database, In step 530 the algorithm calculates the probability of the user returning to the starting point based on the parameters above.

### Dead Reckoning—For Reducing GPS Samples and Thereby Reducing Battery Usage).

In navigation, dead reckoning refers to the process of calculating one's current position by using a previously determined position, or ‘fix’, and updating that position based upon known or estimated speeds during elapsed times taken to traverse known or inferred distances. Dead reckoning uses estimates of speed (or alternatively distance) and direction. For purposes of the inventive algorithm, distance is inferred by learning the average step size of the user and counting the number of steps taken. Initially the step size is set to an average based on a standard that takes into account the height and the frequency of steps of an average person. Calibration is done early on and often enough until enough samples are obtained for a variety of frequencies of steps. Using the aforementioned Pedometer algorithm, the application can estimate the number of steps taken by the user in a more-or-less straight line. We compare this with the actual distance walked using information from the GPS. Then, simply by dividing the distance walked by the number of steps counted, we can get the average step-size for the particular user. The step-size is calculated for various walking paces of the user, where walking pace is defined as the number of steps per second. Interpolation is then used to estimate the step-size for any walking pace. Direction is obtained from the compass sensor inside the phone.

### Reducing False Positives

The method of the present invention attempts to reduce false deductions, for example by identifying the vehicle type:

### 1. Motorbike

A motorbike's acceleration patterns are characterized by accelerations that are similar to a car's but significantly higher. Additionally, when a motorbike takes a turn, it angles towards the ground whilst a car hardly does. Thus, together with the change in the accelerometer, the gyro with the orientation sensors inside the phone identify a much larger change in the angle of the motorbike relative to the ground compared to a car, which maintains a steady angle. Also, a motorbike is able to accelerate from standstill at a much higher average acceleration (over a window of a couple of seconds with a low standard deviation), than is typical for a normal car. Lastly, by sampling the microphone during the accelerometer peaks, the dB of the sound of a motorbike engine is identified as a much higher than that of a car's, The dB can reach 70-80 dB with a frequency of between 250-400 Hz. Further, if Parallel parking or alley docking or other parking motion is not recognized then this spot is excluded.

### 2. Bicycle

If the phone is in the user's pocket, then a pedalling pattern may be identified using the accelerometer. Additionally, when a bicycle takes a turn, it angles towards the ground whilst a car hardly does. The acceleration of a bicycle does not reach the levels of a typical car. On the other hand, many accelerometer peaks are detected at speeds that are not normal for a pedestrian walking.

### 3. Taxi

The system also attempts to reduce false positives by identifying whether the user is the driver of the car or a passenger. The side from which the user entered the car can be identified using the accelerometer, gyroscope and compass, by identifying certain patterns in the movement of the phone whilst entering the car from either the left or right side. This is usually manifested as a small bump in the total accelerometer readings as the user steps into the car, if the phone is in the user's trouser pocket. This way the system can identify if the user is not the driver (having entered from the passenger side). Furthermore, the ‘scoot’ operation of the passenger and driver as they slide into the seat will be in opposite directions: by comparing the ‘scoot’ direction with the direction of driving movement (as derived e.g. from integration of acceleration, or GPS) the identity of the phone-bearer may be revealed.

Generally speaking for all the above classifications (driving, walking, biking, motorbike, taxi, etc) the device sensors are recorded and calculations made on derived values including but not limited to values such as acceleration in the horizontal direction A h, upwards acceleration A z, integrals such as velocity in the horizontal plane V h, velocity in the upwards direction V z, derivatives such as the rate of change of orientation in the horizontal plane O h, and standard deviations such as std(V z), std(O h), and Std(O y). As mentioned above any of these values may be calculated using one or more time windows. For example velocity can be obtained by integrating acceleration over different time windows, and likewise time derivatives, averages, standard deviations and other derived values can all be calculated using a set of different time windows, and any set of these values may be used for state-determination. The state-determination algorithm generally takes the various calculated values as input and outputs a state such as walking, driving, texting, and the like; the algorithm may be any of a multitude known in the art including but not limited to neural nets. SVM, k-means, heuristics, thresholding, voting experts, and the like.

### Learning User's Habits

The engine according to the present invention comprises a learning algorithm, which is constantly learning about its user & adapting itself to his/her habits in order to have a higher success rate in accurately predicting the user's destinations when using different moving means (e.g. car, bicycle, foot) at different hours of the day.

Predicting the probability that the user is on his way to a certain place is accomplished in certain embodiments of the invention by means of:

a. Learning user's most common locations and times to be there: The algorithm identifies the main places where a user goes most of the time (e.g. home, office, etc) and ‘learns’ the usual times that he arrives and leaves these places. These locations plus times may be thought of as four-dimensional points, in which case clusters may be constructed using for example SUM, k-means or other clustering methods, with preference being given to automatic cluster recognition.

b. Area; On a high level, when an event such as “arriving to or leaving a spot” is suspected, if the historical experience of the algorithm with this particular user shows a high success rate in this particular area and/or time, then the confidence of the prediction is higher. It is within provision of the invention to report a confidence along with state, as mentioned above,

c. For each user, a success rate score is accumulated per day of the week, per hour of the day, and per location. Success rate score is based on the number of times recognized as actually having arrived at the location when approaching has been recognized, compared to the number of times that the user approached the location and did not arrive at it.

Power consumption sensitivity (energy-efficiency)

The goal is to retain accuracy while using as little power consumption as possible. The main way of doing this is by using the GPS as little as possible and by using alternative sensors instead. The GPS is used at critical points only and when the dead-reckoning accuracy drops and also depending on the distance from a starting point (when further away then accuracy is less important). The other sensors, particularly the accelerometer, are used to identify the various states and are also sampled for as little time as required.

Events from the accelerometer may be used as triggers for the other sensors, for example:

When driving is suspected, the network location (triangulation of cellphone tower signal and wifi hotspot reception) is used instead of the GPS to identify driving, and then

<img class=“EMIRef” id=“189519655-imgf000015_{—}0002”/>

be disabled again.

<img class=“EMIRef” id=“189519655-imgf000015_{—}0001”/>

During walking the network location may be used instead of the GPS.

Furthermore, it is within provision of the invention to use a low sample rate of the accelerometer (around 1 Hz) most of the time, especially when we recognize a resting state (e.g. phone laid on a table). When some kind of movement state is suspected, only then is the accelerometer frequency increased (to e.g. around 5 Hz) to get a clear understanding of what is happening. When significantly high accelerometer readings are identified (e.g. 0. Ig) then the frequency of the accelerometer samples can be increased even more (for instance to around 40 Hz). When distance from a starting point is large or for any other reason the accuracy of the measurement is less important, the frequency may be lowered again (back to say 5 Hz), depending on the application, but when approaching the starting point (e.g. less than 100 m away), high sample frequency may be used (40 Hz) in order for the dead-reckoning to be most accurate, again depending on the application. Once driving is identified, sample frequency can be returned to 5 Hz.

The gyro is sampled only during driving in order to identify the type of vehicle (car/motorbike/bicycle).

Crowdsourced Parking Solution

Several useful methods may be implemented in light of the information obtained by the aforementioned techniques. As one important example we take the case of parking-state information, which may be used to implement a crowdsourced parking solution that is within provision of the invention.

Generally speaking this method consists of detecting parking events amongst a base of users, and detecting subsequent approach of the driver to the vehicle in an attempt to predict events where drivers leave parking spots. When a driver leaves a public-access parking spot, this spot becomes available to other drivers, and it is an aim of the invention to provide prior notice to one or more users of the system of the location and projected time of this occurrence.

Thus for example when user A of the system parks, his parking location is recorded using the methods detailed above. When the user is subsequently detected to be walking towards the car (e.g. within a certain threshold radius and in the correct general direction of the parked vehicle), an alert is sent to this user asking him if he is indeed about to vacate a parking spot. If the user answers affirmatively, the spot can then be advertised to another user of the system who has indicated that he is looking for a spot. For example, of all the users who have indicated to the system that they are looking for a parking spot at that time, the system may offer the upcoming parking spot to the closest driver; if that driver refuses the spot, then the system may offer the upcoming spot to the next-closest driver, and so on. The location is thus revealed only to one potential parker at a time, preventing strife between multiple parties trying to park in a single newly-available spot.

Obviously there are alternatives to the use of physical proximity for implementation of this system; for example bidding may be implemented such that a given parking spot is simply given to the highest bidder, who has (for example) bid beforehand. Thus the location of the upcoming parking spot is revealed only to this highest bidder, preventing strife between multiple parties trying to park in a single newly-available spot.

The system may be implemented by use of client-side software in addition to server-side software, as shown in FIG. 1 where multiple smartphones 120, 130 are in communication with a server 110. As will be appreciated, by means of the central communication allowed by server 110, information from a given user may be shared with one or more other users. This information may comprise locations and times of expected unoccupied parking spots.

As will be appreciated, the prediction of the time at which a driver is going to leave a parking spot is useful since it allows the system to offer a parking spot to another system user some time before the spot is actually available, allowing the user wanting to park enough time to arrive at the parking spot some time before the spot is actually vacated. In this way the spot is not left free; otherwise, the departing driver either waits for the incoming system user, or vacates the spot before the incoming user has arrived. In the latter case of course other drivers may take the spot before the system user arrives; if the system user arrives before the vacating driver has left, this potential problem is largely avoided since nonusers of the system will unlikely be aware that the vacating driver is in fact vacating, until the actual moment of vacation.

The prediction of when a user will leave a spot may be accomplished as mentioned above by means of detecting a user associated with a given parked car, to be walking in a ‘likely’ direction and/or within a certain radius of that user's assumed parked car. Further methods may be considered for this prediction, such as analysis of the user's historical habits; if it is determined for instance that a particular user always vacates from a parking spot in a small region (e.g. around his work place) at times between 18:00 and 18:15, then if walking is detected within this time frame and it is known to the system that the user has parked in the ‘usual’ region, then a ‘likely parking spot vacation’ future event may be declared and investigated, As mentioned above one method of investigation whether a user is in fact on the way to vacating a parking spot is to simply ask him, for example by means of a popup window, SMS, or the like inquiring whether he is about to vacate a parking spot.

### Parking Location

Another potential application of the state-determination techniques mentioned above is to remind users of their parking spots; rare is the long-term driver who has never failed to recall his most recent parking spot. In such occurrences, the inventive system can be of assistance given that the parking location is known thereto. Thus it is further within provision of the invention that a driver can query the system as to his car's whereabouts, based on the location of last known parking event.

### Statistical Algorithms

It is within provision of the invention to analyze location from a statistical standpoint. For example the following algorithm may be employed to determine daily locations such as ‘home’ and ‘work’, and activities such as walking, driving, biking, and the like. The following algorithm is an example of a possible flowchart or sequence of operations for operation of such a statistical learning system.

1) If user hasn't defined their home location, define home as the place where the user is most often, when day begins and ends, Alternatively home can be defined as the place where user is for longest empty period of night, and/or the place the user sleeps most often, Once ‘home’ has been defined and detected, discard all statistics for it.

2) Treat each day as a unit, which has:

a. a list of places visited on that day, including such information as:

i. time of arrival;

ii. time of departure;

iii location of final destination

b. day of week

c. date

3) For each day of the week:

a. Go over all instances of this day of the week (for example all Mondays, except for holidays which should be ignored or treated like a weekend) and identify all oftise locations except for home) which were visited on some threshold percentage of these days.

b. For each of the aforementioned locations:

i. calculate average and standard deviation for arrival time and departure time.

ii if the standard deviation is greater than some predetermined threshold, mark location as a non-structure location.

iii. otherwise, mark location as a daily structure location for the day of the week being considered.

4) If the user has defined a work location, add this as a daily structure location

5) For each daily structure location: a. if location is a daily structure location for at least a predetermined number of days of the week, and has similar distributions of arrival and departure times:

i. Mark location as a weekly structure location for relevant days.

ii. if there are other days for which the distribution doesn't match (i.e. is sufficiently dissimilar using some measure of similarity such as the mean squared differences), keep the location as a daily structure location for those days

b. otherwise, keep location as daily structure location

6) Go over all days again and mark locations which have been visited at least w % of days, and are not structure locations, as non-structure locations

7) Mark all favorites which are not structure locations, as non-structure locations

8) Store the values:

a. For each weekly structure location: keep average and standard deviation for arrival and departure times over all relevant days

b. For each daily structure location: keep average and standard deviation for arrival and departure times, for one relevant day only

c. For each non-structure location: keep average and standard deviation for duration of time spent there.

i. if user has less than a predetermined number of statistics for the location, keep average and standard deviation for duration of time spent there for all users

9) Run this algorithm once every N days, where N is a predetermined parameter:

10) Variables to determine:

a. x=minimal percentage to consider for daily structure location

b. y=maximal standard deviation for daily structure location

c. z=minimal number of days for weekly structure location d. define similar distribution (average within a of each other, std within b of each other)

e. w=minimal percentage over all weekdays for non-structure location f. u=how often to run algorithm

g. t=minimal number of stats to consider for non-structure location without considering other users

h. policy for holidays (holidays should be kept in database)

i. definition of which points are considered one location (radius? map out all points user goes to and consider them the borders of the location?)

in summary there are 3 types of locations recognized by the system described above:

1. Weekly structure locations: locations which are visited more than once a week on a regular basis, with similar time frames regardless of day of week, such as: work, gym, taking child to school.

2. Daily structure locations: locations which are visited on a specific day of the week at a similar time every week, such as: visiting an elderly family member on a weekly basis, big weekly grocery shopping, or more than once a week but at different times on different days such as She gym.

3. Non-structure locations: locations which are visited often but without a regular schedule such as: the mall, the doctor's office, frequently visited clients (for someone whose job is done in house visits), friends.

Prediction Algorithm

It is within provision of the invention to implement a prediction algorithm, for instance such as that described in the following flow sequence:
If user is driving:
if a structure location is expected with high probability in the near future, notify user when near that location only
Otherwise, notify user if near home or a non-structure location If user isn't driving:
If a structure location is expected with high probability in the near future, calculate p, the probability of the user leaving for this location in the next interval:

p1−(phi(a)−phi(b))/(1−phi(b))

where a=the end of the interval÷travel time, b=the current time+travel time, phi=the z table function for the stats for arrival time for that location

travel time=how long it would take user to get from current location to structure location (for example simply considering distance and average travel speed, or considering current traffic conditions, or the like.)

This is the probability that the user will leave by a if he didn't leave by b. This probability will drop down to 0 if enough time has passed, and user didn't leave.
If the user is currently at a structure location:

calculate p2−the probability of the user leaving in the next interval:

p2=(phi(a)−phi(b))/(1−phi(b))

where a=the end of the interval, b=the current time, phi=the z table function for the stats for leaving time for that location

This is the probability that the user will leave by time a if he didn't leave by b. Again this probability should drop down to 0 if enough time has passed and the user didn't leave yet.

calculate p:

if pi, p2>0, p is their average
otherwise, p is the max
If the user is currently at a non-structure location: calculate p2=the probability of the user leaving in the next interval:

p2=(phi(a)−phi(b))/(1−phi(b))

where a=the amount user will have spent there by she end of the interval, b˜the current amount of time user has already spent there, phi=the z table function for the stats for visit duration for that location. This is the probability that the user will leave after a if he didn't leave after b. As before the probability should drop down to 0 if enough time has passed and user hasn't left.

calculate p:
if p 1, p2>0, p is their average
otherwise, p is max(p1,p2)
if user is at home or at an unknown location, p−p1
Calculate alpha=A+(1−A)*p*(n/N+k), where:

A=a constant chosen by system operators, or automatically
p=probability as calculated above

N=the number of stats taken in to account for calculation of p k−constant determined by the system operators, or automatically
n=number of points in the cluster

Alpha is just a simple of way of defining how early on a user's walk near his car the system decides that the user is on his way to leave his parking spot. E.g. if a user leaves his office every day at 6 pm and then goes on to vacate a parking spot every day, then his alpha will be very high at around 6 pm around his office. Therefore very early on his way out of the office towards the car, the system makes the determination that his spot is about to become available.

It is within provision of the invention to predict location as a function of time by means such as those outlined above. Generally speaking, statistical analysis of behaviour such as location as function of time, day of week, and the like can be employed for purposes of learning the user's habits, daily & weekly routines, and other characteristics.

It is within provision of the invention that learning methods be utilized adapted to learn information about people's habits (in general) with regards to specific places. For example at fast food restaurants people may leave on average faster than from fancier restaurants, people may leave on average an hour after entering a gym but two hours after entering a library, and the like.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

1. A method of determining smartphone user state comprising steps of:
a. gathering sensor data from sensors of said smartphone, comprising acceleration data and magnetometer data;
b. calculating derived values from said sensor value, said derived values selected from the list consisting of: acceleration in absolute coordinates, orientation, velocity, standard deviations thereof, and rates of change thereof;
c. determining user state from said derived values by use of classification means;
wherein user state is determined by means of sensor data of said smartphone without reference to GPS data.

2. The method of claim 1 wherein said classification means are selected from the group consisting of: thresholding; SVM; k-means; Ward's method; and hierarchical clustering.

3. The method of claim 3 wherein said user state data is determined by use of IMU data from said user's smartphone.

4. The method of claim 3 wherein said user state is selected from the group consisting of: walking; driving; biking; running; riding bus; passenger in car.

5. The method of claim 3 wherein said state of driving is determined by use of thresholding values in the coordinate frame of the earth selected from the group consisting of: horizontal acceleration Aₕ, upwards acceleration A_{z}, velocity in the horizontal plane Vₕ, velocity in the upwards direction V_{z}, the rate of change of orientation in the horizontal plane Oₕ, and standard deviations std(V_{z}), std(Oₕ), and Std(O_{y}).

6. A method for informing users of imminently available parking spots comprising steps of:
a. gathering user state data;
b. determining a user parking position when said user state changes from driving to walking;
c. detecting when said user re-approaches said user parking position;
d. notifying one or more other users of an imminent unoccupied parking space at said user parking position;
wherein imminently available parking spaces are detected before they occur, without necessarily requiring use of GPS.

7. The method of claim 6 wherein said user state data is determined by use of IMU data from said user's smartphone.

8. The method of claim 6 wherein said user state is selected from the group consisting of: walking; driving; biking; running; riding bus; passenger in car.

9. The method of claim 6 wherein said step of detecting when said user re-approaches said recorded user position is accomplished by detecting a user state of walking within a predetermined radius of said recorded user parking position.

10. The method of claim 6 wherein said state of driving is determined by use of thresholding values in the coordinate frame of the earth selected from the group consisting of: horizontal acceleration Aₕ, upwards acceleration A_{z}, velocity in the horizontal plane Vₕ, velocity in the upwards direction V_{z}, the rate of change of orientation in the horizontal plane Oₕ, and standard deviations std(V_{z}), std(Oₕ), and Std(O_{y}).

11. The method of claim 6 further reminding users who have parked of their parking locations.

12. A system adapted to inform users of imminently available parking spots comprising steps of:
a. gathering user state data;
b. determining a user parking position when said user state changes from driving to walking;
c. detecting when said user re-approaches said user parking position;
d. notifying one or more other users of an imminent unoccupied parking space at said user parking position;
wherein imminently available parking spaces are detected before they occur, without necessarily requiring use of GPS.

13. The system of claim 12 wherein said user state data is determined by use of IMU data from said user's smartphone.

14. The system of claim 12 wherein said user state is selected from the group consisting of: walking; driving; biking; running; riding bus; passenger in car.

15. The system of claim 12 wherein said step of detecting when said user re-approaches said recorded user position is accomplished by detecting a user state of walking within a predetermined radius of said recorded user parking position.

16. The system of claim 12 wherein said state of driving is determined by use of thresholding values in the coordinate frame of the earth selected from the group consisting of: horizontal acceleration Aₕ, upwards acceleration A_{z}, velocity in the horizontal plane Vₕ, velocity in the upwards direction V_{z}, the rate of change of orientation in the horizontal plane Oₕ, and standard deviations std(V_{z}), std(Oₕ), and Std(O_{y}).

17. The system of claim 12 further reminding users who have parked of their parking locations.

18. A method for estimating likelihood of a user being at a given location using historical data to perform statistical analysis of including location as function of time and day of week for purposes of learning said user's habits, daily routines, weekly routines, and average residence time at given locations, comprising calculation of the function parameter alpha=A+(1−A)*p*(n/N+k), where: A, k are constants, p is the historical probability of the action to be predicted, N the number of points in the historical record, and n the number of points in the cluster.
